(19) United States
(12) Patent Application Publication
(10) Pub. No.: US 2026/0175978 A1
(43) Pub. Date: Jun. 25, 2026

(54) AIRCRAFT SERVICE MANAGEMENT SYSTEM

(71) Applicant: Airbus Operations GmbH, HAMBURG (DE)

(72) Inventor: Frank QUATMANN, HAMBURG (DE)

(21) Appl. No.: 19/425,213

(22) Filed: Dec. 18, 2025

(30) Foreign Application Priority Data
Dec. 19, 2024 (DE) 10 2024 138 931.1

(51) Int. Cl. B64D 11/00; G06Q 10/087

(52) U.S. Cl. CPC B64D 11/0015; G06Q 10/0877

(57) ABSTRACT

A service management system for an aircraft. The service management system is configured to provide a passenger with a service which is closely related to content provided to the passenger on an entertainment system on the aircraft. The service may include an item that is dispensed in the galley of the aircraft, and the system may determine if the item is in stock. Also an aircraft with such a system.

### CROSS-REFERENCE TO RELATED APPLICATIONS

This application claims priority to German Patent Application No. 10 2024 138 931-1 filed on Dec. 19, 2024, the entire disclosure of which is incorporated herein by way of reference.

### FIELD OF THE INVENTION

The present disclosure relates to a service management system for an aircraft that determines a service for a passenger depending on content consumed in an entertainment system. In particular, the present disclosure relates to a service management system for an aircraft and to an aircraft with such a system that, on a galley dispensing device, suggests a service appropriate to the content at a time also dependent on the service for a passenger to whom content is provided in an entertainment system.

### BACKGROUND OF THE INVENTION

Earlier in-flight entertainment systems offered all passengers the same content at the same time. For example, on longer flights, a film could be shown on one or more screens available to passengers. This enabled services such as food or beverage service.

In today's aircraft, most entertainment systems are personalized for each passenger. This means that each passenger can access content from the entertainment system at any given time. Therefore, a uniform service for all passengers is not possible without disturbing other passengers while they are consuming content.

Furthermore, a system is planned for the aircraft that adjusts certain device settings related to each passenger's seat, for example, based on user preferences or information about the passenger from previous flights. Thus, the system can, for instance, adjust or change ventilation, seat position, seat massage function, or window darkening near the passenger, if this suits the passenger's habits.

The present disclosure is based on an objective of improving the service capabilities in an aircraft.

### SUMMARY OF THE INVENTION

This problem may be solved by the present invention as described in one or more embodiments herein.

According to a first aspect for a better understanding of the present disclosure, a service management system for an aircraft comprises a database that stores a plurality of services that can be offered to a passenger, each in conjunction with at least one keyword, a communication interface for data communication with at least one passenger seat entertainment system and an output device of at least one galley, and a control unit. The service management system can be centrally located in the aircraft and communicate with a plurality of passenger seats and a plurality of galleys via the communication interface, in particular exchanging data. The communication interface can be, for example, a data communication interface, a bus, a network interface, or the like, wherein at least the at least one entertainment system and the at least one galley are connected to the communication interface. The communication between the communication interface and the entertainment system or galley can be wired or wireless.

The control unit is configured to: receive, via the communication interface, content information and time information relating to content provided to a passenger by the corresponding entertainment system; query at least one service from the database based on the content information, whereby the content information is transmitted to the database as a keyword; determine a service time depending on the time information of the content; and transmit, to the output device, information identifying the at least one queried service, the service time, and the passenger to whom the content is provided.

The service management system is thus able to inform service personnel (such as flight attendants) via the service terminal that a specific service can be offered to a particular passenger at a specific time. This enables the targeted offering of a service that matches the content currently being consumed by the passenger. The passenger thereby has a positive experience during the flight, which enhances the aircraft operator's (e.g., the airline's) reputation. Conversely, such a service can also be sold to the passenger, generating additional revenue during the flight.

Unlike the previous practice of adjusting the passenger's seat environment (ventilation, temperature, lighting, seat functions, etc.), the passenger now experiences a much more personalized and targeted service. Furthermore, the passenger is not simply offered a service through the entertainment system, similar to typical advertising, but rather the service can be provided directly and personally by the flight attendant at the time of service. This creates a positive atmosphere for the passenger, as they feel personally addressed and cared for.

Just as an example, at the end of a particular film a user is watching via the entertainment system, say a James Bond movie, a flight attendant could surprise them with a drink appropriate to the film, such as a vodka martini (stirred, not shaken). If the drink is already prepared and in the passenger's possession at the end of the film, there is a very high probability that the passenger will accept this service and be pleasantly surprised.

In one implementation variant, the content information may already be known to the service management system and does not need to be explicitly received via the communication interface. For example, the content information may also be stored in the database (or a separate database or dedicated content repository). Since the content itself may also be stored centrally on the aircraft, the service management system can, for example, access this centrally stored information. The service management system then receives the time information for the content from the entertainment system and can subsequently retrieve the corresponding content information. Naturally, the content repository can also be part of the service management system.

In one implementation variant, the control unit can be configured to determine the service time by defining an end point for content delivery and setting the service time to that end point. This ensures the passenger is not disturbed while consuming the content. Furthermore, the temporal reference point at the end of the content delivery is very short, so the passenger is still in the mood created by the content and is highly likely to accept the service.

In one implementation variant, the service management system can further include an inventory tracking device designed to record the stock of items stored in at least one galley. For example, the inventory tracking device can include one or more sensors, cameras, or similar devices that monitor the stock of stored items. Alternatively or additionally, the inventory tracking device can also register when an item is removed, for example, by detecting a barcode, QR code, RFID chip, or by having the flight attendant scan such a code or chip when removing the item.

Furthermore, the control unit can be configured to: identify at least one item required to perform the requested service, and query the inventory system to determine whether the identified item is stored in the galley. This allows the service management system to ascertain whether all items necessary for performing the service are present on the aircraft. Referring to the example above, it can be checked, for instance, whether vodka, ice, an olive, and a martini glass for serving the vodka martini are still available.

In one implementation variant, the control unit can be configured to: discard the requested service if the identified item is not in stock. This ensures that passengers are only offered services that are available at the requested time. The service management system is thus able to offer services in a targeted manner and utilize the remaining (stored) items on the aircraft. Consumption balancing is also possible, meaning that the system aims to consume all stored items as evenly as possible by offering various services.

In one implementation variant, the control unit can be configured to dispense information onto the dispensing device in which the identified item is stored (at least one item in the galley). This allows the service to be prepared before the service time, and the staff (flight attendants) can obtain all necessary items in a timely manner. Naturally, the control unit can also transmit information to the dispensing device (for example, via the communication interface), which can then be displayed there, instead of directly accessing the device to dispense information.

In one implementation variant, the content could be a film, a TV series, a piece of music, current weather data, current map data in the area surrounding the aircraft, or a game. A specific service or multiple services can be offered for each of these. For a film, TV series, or game, a featured item, drink, meal, or similar item could be offered to the passenger. The same applies to a piece of music, for example, depending on the lyrics, the genre, and other factors. Based on current weather data, the passenger could be offered items such as sunglasses, an umbrella, or similar things they might be thinking about while viewing the weather information. Based on current map data, travel guides, postcards, sunglasses, an umbrella, and similar items could be offered.

Services include not only drinks, meals, or items, but also digital services such as general internet access, access to paid content, digital postcards, sending messages to relatives, and similar features. It is also possible to offer passengers a shopping recommendation as part of the service, such as a specific drink, a visit to an attraction at the destination, or a special discount at a shop or restaurant there.

In one implementation variant, the content information can be content metadata. Metadata is data that does not represent the actual content, such as image/video data, audio data, and the like, but rather provides additional information about the content. Naturally, the metadata can also contain information about specific locations (within the displayed area of the map data), weather phenomena, and similar information, which can be queried by the service management system and used to determine the correct service for the passenger.

In one implementation variant, the control unit can be configured to determine the service time by setting the service time to a point in time contained in the metadata.

In one implementation variant, the time contained in the metadata can mark a scene, the beginning of a chapter, the start of the content, the end of the content, the beginning of the credits, and similar events. Using the example above, the vodka martini could, for instance, be served/offered at a time when James Bond also receives the drink (i.e., scene-dependent).

In one implementation variant, the control unit can further be configured to: query passenger data from at least one sensor designed to detect the presence and/or information about a passenger in the passenger seat. Passenger data includes not only presence (for example, whether the passenger has just stood up, or whether a passenger is even sitting in the seat while content is being delivered via the entertainment system), but also biometric data (body data), such as body temperature, posture, eye openness, arousal (joy, fear, etc. while consuming the content), and similar information. This allows the service to be offered in such a way that the service is not offered to the passenger if they are about to go to the restroom, are asleep, excited, or similar. Conversely, the service can be offered to the passenger precisely because they are consuming the content with enjoyment and/or excitement. The sensor can be located, for example, in the passenger seat, in the entertainment system (i.e., in a seat in front of the passenger), in the floor, in the ceiling, or similar locations.

Alternatively or additionally, the control unit can be configured to: query passenger data from at least one personal service unit, which is configured to detect the presence and/or information about a passenger in the passenger seat. A personal service unit (also called a personal service unit) service the Personal Service Unit (PSU) is typically located above passenger seats and includes at least one element assigned to a specific passenger (for example, a reading light, an air vent, and similar items). This allows for easy implementation of passenger-specific data collection. Since the Personal Service Unit usually communicates with a central aircraft system (for example, when a passenger presses the service button, the central system knows which seat or row the service call is from), transmitting passenger data to the service management system is very straightforward.

In one implementation variant, the control unit can further be configured to: query passenger information about the passenger to whom the content is being provided, in particular from a data storage system designed to store personal passenger profiles. Passenger information can be collected during the flight by the service management system or originate from a data storage system located off-aircraft. For example, this could include recorded or stored user preferences or specific user behavior (such as regularly ordering a particular beverage after consuming a specific type of content) that is already known to the aircraft operator. The passenger's personal profile could, for example, originate from a loyalty program (frequent flyer program) that the service management system retrieves from a network and/or, for example, retrieves from fellow passengers before the flight and stores for the duration of the flight. Personal profiles can also include profiles from social networks (Facebook, Instagram, TikTok, LinkedIn, etc.).

For example, passenger information can be used to determine whether a passenger drinks (or is allowed to drink) alcohol, has preferences for certain meals, beverages, items, digital services, etc. This allows the service offered to the passenger to be even more personalized to match their consumption habits.

In one implementation variant, the control unit can further be configured to: query local weather data and, upon receiving weather data indicating a disruption to the flight, discard at least one service in question. This can prevent, for example, a passenger from being offered a drink if turbulence occurs a few minutes later, preventing them from enjoying it or causing them to spill it. It can also prevent a service from being prepared and having to be canceled, thus avoiding the waste of necessary items (such as melting ice, coffee getting cold, etc.).

In one implementation variant, the control unit can further be configured to: query destination information for an aircraft's destination, filter the destination information based on the content information, and provide the filtered destination information as additional content to the entertainment system. For example, in line with the example mentioned above, information about a James Bond museum or a related exhibition, a bar, or similar at the destination can be displayed. Special vouchers or price reductions for places and/or events at the destination can also be offered, generating additional revenue for the aircraft operator through a corresponding compensation system.

According to a second aspect for a better understanding of the present disclosure, an aircraft includes a service management system according to the first aspect or at least one of the disclosed implementation variants.

The present disclosure is not limited to the aspects and variants described herein, and in particular not in the order described. Specifically, the description of the aspects and variants should not be understood as a specific restriction to groups of features. Rather, combinations of the aspects and variants that fall under the scope of this disclosure can also be formed. Thus, each variant or each feature described as optional can be combined with any of the other aspects or variants, or combinations thereof.

### BRIEF DESCRIPTION OF THE DRAWINGS

The present disclosure is described below with reference to exemplary embodiments shown in the FIGURE, wherein:

FIG. 1 shows a schematic service management system for an aircraft.

### DETAILED DESCRIPTION OF THE PREFERRED EMBODIMENTS

The following description discusses certain details for the purpose of explanation, not limitation, in order to provide a general understanding of the present disclosure. Naturally, the present disclosure can be implemented through other embodiments that differ from these specific details.

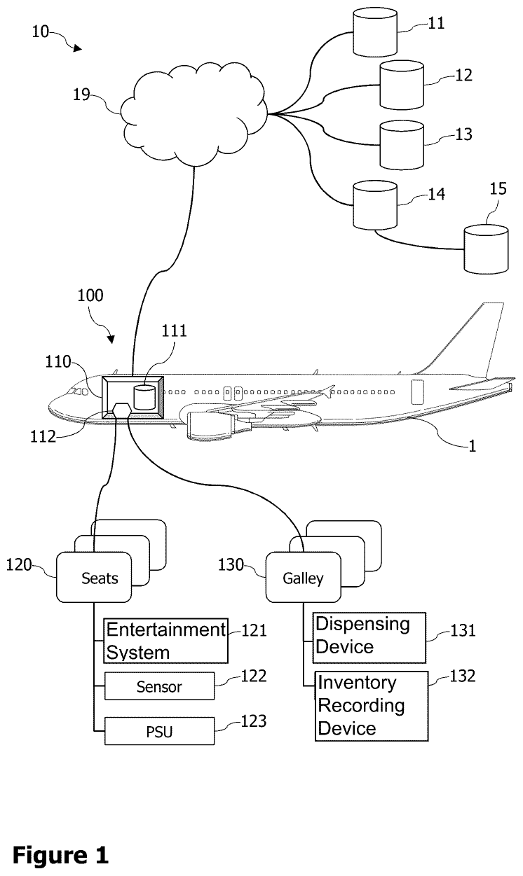

FIG. 1 shows an aircraft 1 with a service management system 100. The service management system 100 can be implemented, for example, by appropriate hardware and/or software. FIG. 1 shows, by way of example and schematically, a control unit 110, such as a processor, server, and the like, which executes the service management system 100.

The service management system 100 comprises a database 111 and a communication interface 112. The database 111 stores at least a number of services that can be offered to a passenger. Each service is stored in conjunction with at least one keyword to make the service automatically retrievable.

The communication interface 112 is used for data communication with other components of the aircraft 1. The aircraft 1 can, for example, include a plurality of seats 120 (or rows of seats) and at least one galley 130. The communication interface 112 can establish wired or wireless communication and exchange data with these elements 120 and 130 of the aircraft 1.

Each of the multiple seats 120 is equipped with an entertainment system 121, also called an infotainment system, designed to provide content to the passenger in that seat 120. The entertainment system 121 typically includes at least one screen and at least one input device (neither shown), which the passenger uses to operate and control the entertainment system 121. For example, the passenger can select a film from a variety of films in the entertainment system 121 to view it on the screen and listen to the audio through headphones. This selection, as well as further control of the content (interaction with the entertainment system 121), can be made using the input device.

The galley 130 (or each of the galleys) comprises a dispensing device 131 and an inventory recording device 132. The dispensing device 131 may also include a screen or a loudspeaker (neither shown) or similar equipment for displaying information to flight attendants. The inventory recording device 132 may be configured to record an inventory of items stored in the galley 130.

If the aircraft 1 is equipped with several galleys 130, an inventory recording device 132 can be implemented in each galley 130. Alternatively, at least one inventory recording device 132 can be implemented centrally to record the inventory in more than one galley 130. The recording of the inventory (stored items), in particular their quantity, storage location, etc., can be carried out using any known technology. Barcodes, QR codes, RFID chips, and similar technologies attached to the items are mentioned only as examples.

The service management system 100 can also be connected to a network 10 located outside the aircraft 1. FIG. 1 shows, by way of example only, a data transmission network 19 through which the service management system 100 of the aircraft 1 can access information technology 11 to 15 located on the ground. This information technology can consist of various servers, databases, and similar infrastructure from which the service management system 100 can retrieve data.

By way of example only, this could include a content storage device 11, which stores a variety of content that can be provided on the entertainment system 121; a service storage device 12, which stores a number of services (and can, for example, transfer them to the database 111); an advertising storage device 13, which stores various advertisements that can be provided on the entertainment system 121; and a platform 14 of the aircraft operator (the airline). The aircraft operator platform 14 could, for example, contain passenger data, in particular about passengers who are on the next/current flight of aircraft 1.

The aircraft operator platform 14 can also be connected to a data storage device 15, which is configured to store personal profiles of passengers. These personal profiles can be profiles stored by the aircraft operator, such as those from a frequent flyer program. Alternatively, or additionally, they can also be profiles from social networks (Facebook, Instagram, TikTok, LinkedIn, etc.) to which the aircraft operator platform 14 can access.

The control unit 110 is now configured to receive content and time information via the communication interface 112 for content provided to a passenger by the corresponding entertainment system 121. This content can include a film, a series, a piece of music, current weather data, current map data in the vicinity of aircraft 1, current flight data, a game, destination information, etc. The content can be provided, for example, by the database 111 or a content server not shown on the aircraft 1 and displayed at an output device of the entertainment system 121 associated with the passenger's seat 120.

Control unit 110 now queries at least one service from database 111 based on the content information. At least part of the content information can be transmitted to database 111 as a keyword to locate one or more services within it. For example, the content information can include metadata such as the title, author, contributors, creation date, timestamps (such as the beginning of one or more scenes, a chapter, the start of the content, the end of the content, the beginning of the credits in a film, etc.), location information, and more. When accessing database 111, at least part of the metadata can be used as a keyword to find (filter) at least one service that is stored with the corresponding keyword.

The control unit 110 is further configured to determine a service time based on the content's time information. The service time represents the point in time at which the service should be offered to the passenger. For example, the control unit 110 can determine the service time by specifying an end point for content delivery and setting the service time to that end point. Of course, any service time can be set by the control unit 110; however, a service time that is as close as possible to a specific aspect of the content offers the greatest chance of the passenger accepting the service immediately. The temporal relationship to the consumed content is relevant here because a passenger might be surprised by a service and, still in the mood from consuming the content, be pleased by it and thus accept the service.

To further refine both the timing and selection of services, the control unit 110 can also be configured to query passenger data from at least one sensor 122 or a personal service unit 123. The sensor 122 and/or the personal service unit 123 can be configured to detect the presence and/or information about a passenger in their assigned seat. This allows for the detection of not only the passenger's mere presence in the seat, but also their mood (state of mind) and/or their attention to the content (is the passenger asleep?). A passenger who is enjoying the content is likely to be most likely to accept (unsolicited) service and respond positively to it.

Furthermore, the control unit 110 can be configured to retrieve passenger information about the passenger to whom the content is being provided from an (external) data storage device 15. For example, it can access one or more personal profiles of the passenger stored in the data storage device 15 (or download corresponding profile information for several passengers prior to the flight). The passenger information can include, in particular, user preferences, age, gender, or other passenger-specific information that enables a service tailored to the passenger.

The control unit 110 is further configured to transmit information to the dispensing device 131 in at least one galley 130 to identify the requested service. The service time and the passenger to whom the service is provided are also transmitted to the dispensing device 131. This allows a flight attendant to prepare the service identified by the service management system 100 in a timely manner and offer it to the passenger at the scheduled service time.

The control unit can, for example, identify at least one item required to perform the requested service and query the inventory recording device 132 to determine whether the identified item is stored in at least one of the galleys 130. The necessary item can be identified by querying the database 111 for the corresponding service. In other words, the database 111 can also store all the items required for a service.

This service management will now be explained in more detail using a specific example. A passenger might, for instance, have accessed and are playing a James Bond film via entertainment system 121. From the film's metadata (content), control unit 110 can query when the film ends, when the credits begin, when a specific scene takes place, what specific characteristics a character in the film has, etc. It is probably common knowledge that James Bond usually drinks a vodka martini stirred, not shaken. The control unit can query this information via the content's metadata or by accessing other content databases (such as Wikipedia).

Using data from sensor 122 and/or service unit 123, control unit 110 can further determine whether the passenger is actually watching the film or has forgotten to stop it, and whether the passenger is watching the film with enthusiasm, for example. If the latter is the case, control unit 110 can access personal profiles, for example, data storage 15, to determine whether the passenger is drinking alcohol, and furthermore, using data from sensor 122/123, determine whether the passenger is thirsty and therefore interested in a vodka martini.

By querying the inventory recording device 132 in at least one galley 130, the control unit 110 can determine whether vodka, ice, an olive, and the appropriate glasses are available. If so, the control unit 110 can add this service to a list of possible services.

Since the enjoyment of a drink may be spoiled by a turbulent flight, the control unit 110 can also query local weather data to find out if a disruption to the flight is likely to occur in the near future (the next 15 to 45 minutes).

Finally, control unit 110 will determine an (optimal) service time. This can be done using time information, for example from the metadata. The vodka martini could, for instance, be served during a specific scene in which James Bond also receives this cocktail, or after the film, or as the end credits begin.

Control unit 110 can also be configured to decline a service if any of the information and/or queries suggest this. For example, no beverage should be served in bad weather because the passenger would not be able to enjoy it during turbulence. Similarly, no alcoholic beverage should be served if the passenger is too young, does not drink alcohol, etc. The service must also be declined if required items are not available on aircraft 1.

The control unit 110 now transmits information to the output device 131 to identify the at least one service, the service time, and the passenger to whom the service is to be offered. Furthermore, additional information obtained can also be transmitted to the output device 131, such as in which galley 130 the ingredients for the vodka martini can be found, that no turbulence is expected for the next 30 minutes, etc.

The service management system 100 can also query destination information for a destination of aircraft 1 and filter it based on the content information (the content provided to the passenger). The filtered destination information can be provided as additional content to the entertainment system. This allows a digital service to be offered to the passenger, informing them, for example, about specific information at the destination. Just as an example, the system could highlight a James Bond exhibition, a particular bar with an award for vodka martinis, and similar attractions. Vouchers can also be offered to the passenger. Information for this could, for example, originate from advertising storage 13.

Due to its content-related approach and optimized service timing, the service management system presented here enables the offering of 100 targeted services to passengers. This can increase the value for the aircraft operator (the airline), for example, through a better ranking in flight service. Furthermore, additional revenue can be generated, for example, through the sale of the service itself, the sale of vouchers, or receiving a share of admission fees for exhibitions and similar events.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A service management system for an aircraft, the service management system comprising:
a database storing a plurality of services to be offered to a passenger, each service associated with at least one keyword;
a communication interface for data communication with at least one entertainment system of a passenger seat and a dispensing device of at least one galley; and
a control unit configured to:
receive, via the communication interface, a content information and a time information, both, for a content provided to a passenger through the at least one entertainment system,
query at least one service from the database based on the content information, wherein the content information is submitted to the database as a keyword,
determine a service time based on the time information of the content, and
transfer to an output device information to identify the at least one service, the service time, and the passenger to whom the content is provided.

2. The service management system according to claim 1, wherein the control unit is further configured to:
determine the service time by determining an end of the content and by setting the service time to the end of the content.

3. The service management system according to claim 1, further comprising:
an inventory recording device configured to record an inventory of items stored in the at least one galley, and
wherein the control unit is further configured to:
identify at least one item necessary for carrying out the at least one service, and
to determine, via the inventory recording device, whether the at least one item is stored in the at least one galley.

4. The service management system according to claim 3, wherein the control unit is further configured to:
discard the at least one service when the at least one item is not in stock; or
dispense, via a dispensing device, the at least one item when stored in the at least one galley; or
both.

5. The service management system according to claim 1, wherein the content is selected from a group consisting of: a film, a series, a piece of music, a current weather data, a current map data in a vicinity of the aircraft, a game, a metadata of the content, and combinations thereof.

6. The service management system according to claim 5, wherein the control unit is further configured to determine the service time by setting the service time to a time contained in the metadata.

7. The service management system according to claim 6, wherein the contained in the metadata identifies a scene, a chapter beginning, a beginning of the content, or an end of the content.

8. The service management system according to claim 1, wherein the control unit is further configured to:
query, via at least one sensor, passenger data regarding a presence or absence of a passenger in the passenger seat; or
query, via at least one personal service unit, passenger data regarding a presence or absence of a passenger in the passenger seat; or,
both.

9. The service management system according to claim 1, wherein the control unit is further configured to:
query passenger information about the passenger to whom the content is provided; or
query local weather data, and, when the local weather data indicates a disruption to a flight, discard the at least one service.

10. The service management system according to claim 1, wherein the control unit is further configured to:
query a destination information for a flight destination;
filter the destination information based on the content information; and
provide a filtered destination information as additional content to the entertainment system.

11. An aircraft comprising:
the service management system according to claim 1.
